(19) United States
(12) Patent Application Publication
(10) Pub. No.: US 2025/0368450 A1
(43) Pub. Date: Dec. 4, 2025

(54) BOTTLE PROCESSING DEVICE AND METHOD

(71) Applicant: BE WTR SA, Lausanne (CH)

(72) Inventors: Etienne LEBRETON, Crissier (CH); Roman Vuillet, Bussigny (CH)

(73) Assignee: BE WTR SA, Lausanne (CH)

(21) Appl. No.: 19/226,775

(22) Filed: Jun. 3, 2025

(30) Foreign Application Priority Data
Jun. 3, 2024 (CH) 000594/2024

(51) Int. Cl. B65G 17/12; B65G 17/32; B65G 21/16; B65G 47/252; B67C 7/00

(52) U.S. Cl. CPC B65G 17/12; B65G 17/323; B65G 21/16; B65G 47/252; B67C 7/0026; B67C 7/0073; B65G 2201/0247; B67C 2007/006; B67C 2007/0066

(57) ABSTRACT

The present invention relates to a compact bottle processing device comprising:
an automatic bottle conveyor unit for moving a plurality of bottles along a closed circuit,
a gripping area enabling an operator to place a bottle from the plurality of bottles on the conveyor unit and/or to pick up a bottle from the plurality of bottles on the conveyor unit,
a bottle cleaning station,
a bottle filling station,
a bottle encapsulation station,
   each of these stations being arranged along the closed circuit, so that a bottle passes successively through the cleaning station, the filling station and the encapsulation station as it is moved by the conveyor unit, wherein a length of the closed circuit is less than or equal to 20 m, preferably less than 15 m.

The invention also relates to a method of processing bottles using the device described above.

This application claims priority from Swiss patent application CH20240000594 of Jun. 3, 2024, the contents whereof are entirely incorporated

### TECHNICAL DOMAIN

The present invention relates to a compact device for bottle processing, in particular cleaning, filling and encapsulation, as well as to a method implementing the device.

### BACKGROUND ART

In the food sector, glass bottles are a preferred container for most beverages. Indeed, glass has a number of well-known advantages, not only in terms of liquid conservation, but also in terms of health and the environment. Examples include:
Chemical neutrality: Glass is a neutral material that does not react with the content of the bottle, unlike plastics which can sometimes release chemicals.
Absence of contaminants: Glass contains no potentially harmful substances such as phthalates or Bisphenol A (BPA), which are found in some plastics.
Hygiene: Glass is easier to sterilize and clean, reducing the risk of bacterial contamination.
Recyclability: Glass is fully recyclable and can be recycled ad infinitum without loss of quality or purity. This reduces the amount of waste sent to landfill and the demand for raw materials.
Sustainability: Glass bottles are often more durable and can be reused several times before needing to be recycled.
Perception of quality: Glass bottles are often perceived as more upscale, which can enhance the brand image of the products they contain.

Of all these advantages, sustainability has taken on particular importance in recent years, in view of current ecological considerations. The circular reuse of glass bottles, however, requires the creation of processing facilities, some of which are quite extensive, so that the bottles can be put back into circulation.

Several steps are usually carried out before a bottle can be reused, including:
bottle condition check (visual or automated)
bottle cleaning, possibly including disinfection.
filling the bottle with a new beverage
encapsulation/closure by means of a capsule or stopper
possibly printing a minimum durability date or other information

Existing solutions are essentially divided into two categories of distinct scope. On the one hand, there are combinations of machines arranged in a “bottling line”, generally on an industrial scale. While offering high productivity, these bottling lines require a large floor area, of the order of several hundred or thousands of square meters. Consequently, these lines are generally installed outside urban centers where most consumption takes place. As a result, a vast transport network is required, usually by truck, which has a considerable ecological impact, as the water sources do not generally correspond with the urban areas where most of the water is consumed.

On the other hand, there are manual workshops combining a bottle washer, a tap and an encapsulation system. In such workshops, the bottle washer is often an improved dishwasher, where the lower washing rotor is replaced by a grid of independent vertical jets penetrating each bottle. In this way, every bottle is cleaned. Cleaning and disinfection, as well as rinsing sequences, are carried out in a single chamber, with a consequent loss of chemicals, since the chamber has to be emptied between each stage. There is no cleaning-in-place process as in bottling plants. Filling is carried out by a water fountain whose water line is sanitized, but not disinfected to the same level of cleanliness. Once out of the dishwasher, the bottle is handled and filled, then the cap is positioned by hand before being crimped.

Certain types of establishment, such as hotels or restaurants are major consumers of bottled drinks. A hotel or restaurant wishing to avoid the use of single-use plastic bottles and avoid transporting the bottles can resort to one of the following alternatives:
Integrate a manual filtered water washing and filling unit into the building, or an intermediate solution. The main disadvantage of this alternative is the hygiene risk associated with manual handling. Bottling work is unskilled, which means high staff turnover and increased hygiene risks. Additionally, manual handling leads to a drop in productivity, which has to be weighed against the savings in bottle transport.
Buy glass bottles, which can then be transported and possibly reused, if a local source offers this. Glass bottles are heavy, which increases transport costs.

There is therefore a need for compact devices that allow circular bottle circulation, avoiding the need for transport. At the very least, these systems must be able to wash, fill and encapsulate the bottles without human contact, in a clean room protected from aerosols.

In other words, there's a need for circular water bottle cleaning and filling solutions that can be integrated into a facility, at a level of hygiene and productivity equivalent to industrial solutions.

### BRIEF SUMMARY OF THE INVENTION

One aim of the present invention is to provide a bottle processing device free from the limitations present in the prior art.

Another aim of the invention is to offer a bottle processing device that is both compact and cost-competitive with large industrial plants.

A further aim of the invention is to offer a compact bottle processing device that is competitive in terms of hygiene levels with large industrial plants.

According to the invention, these aims are achieved in particular by means of a compact bottle processing device comprising:
an automatic bottle conveyor unit for moving a plurality of bottles along a closed circuit,
a gripping area enabling an operator to place a bottle from the plurality of bottles on the conveyor unit and/or to pick up a bottle from the plurality of bottles on the conveyor unit,
a bottle cleaning station,
a bottle filling station,
a bottle encapsulation station,
   each of these stations being arranged along the closed circuit, so that a bottle passes successively through the cleaning station, the filling station and the encapsulation station as it is moved by the conveyor unit,
   wherein a length of the closed circuit is less than or equal to 20 m, preferably less than 15 m.

In one embodiment, the conveyor unit comprises a plurality of gripper arms, each gripper arm supporting a bottle throughout the closed circuit.

In one embodiment, each gripper arm comprises a rotating wrist for rotating a bottle on the gripper arm.

In one embodiment, the conveyor unit is configured to move the plurality of bottles fractionally at time intervals between successive positions along the closed circuit.

In one embodiment, the time interval is between 5 and 20 seconds.

In one embodiment, the gripping area is dimensioned to accommodate a number of gripper arms between 5 and 10 simultaneously.

In one embodiment, the closed circuit is oblong in shape.

According to one embodiment, a width of the device is less than 5 m, preferably 4 m, and a length of the device is less than 5 m, preferably 4 m.

In one embodiment, the device comprises at least one additional station selected from: a rinsing station, a drying station, a disinfection station and/or a printing station.

In one embodiment, the device comprises a protective enclosure arranged to prevent access to the conveyor unit from outside the device, with the exception of access via the gripping area.

In one embodiment, the device comprises an overpressure cabin, with the filling station and encapsulation station arranged inside the overpressure cabin.

According to one embodiment, the device is arranged in a first stage and a second stage above the first stage, the first stage comprising a plurality of compartments configured to contain operating units of the cleaning, filling and/or encapsulation stations, and the second stage comprising the conveying unit and the cleaning, filling and encapsulation stations.

In one embodiment, the operating units may comprise one or more of the following: a pressurized container for gasifying a liquid, a compressor, a cleaning agent vessel and/or a liquid filtration device.

In one embodiment, the encapsulation station comprises a capsule dispensing unit and a capsule crimping unit.

According to the invention, these aims are also achieved in particular by means of a bottle processing method comprising the steps of:
placing the empty bottle on a gripper arm in a gripping area of a bottle processing device as described above,
cleaning the empty bottle using a cleaning station on the processing unit,
filling the empty bottle with a liquid using a filling station on the processing device,
encapsulating the filled bottle by means of an encapsulation station of the processing device,
retrieving the filled and encapsulated bottle from the gripper arm in the gripping area,
   the bottle arrangement and retrieval steps being carried out by an operator, and the bottle being automatically moved along a closed circuit by means of a conveyor unit of the processing device, with cleaning, filling and encapsulation stations arranged along the closed circuit.

According to one embodiment, the method comprises a first step of rotating the empty bottle before the cleaning step so as to orient a bottle neck in a cleaning direction, and a second step of rotating the empty bottle after cleaning and before filling so as to orient the bottle neck in a filling direction, both rotation steps being performed by means of a rotating wrist of the gripper arm on which the bottle is arranged.

In one embodiment, each bottle is rotated by 180° during the first rotation step and by 180° during the second rotation step.

### BRIEF DESCRIPTION OF FIGURES

Examples of implementation of the invention are shown in the description illustrated by the appended figures in which:

FIG. 1 schematically illustrates a bottle processing device according to the invention.

FIG. 2 schematically illustrates a bottle processing device comprising various optional processing stations.

FIG. 3 shows a front view of a bottle processing device according to the invention.

FIG. 4 illustrates a rear view of a bottle processing device according to the invention.

FIGS. 5 and 6 illustrate perspective views of a bottle processing device according to the invention.

### EXAMPLE(S) OF EMBODIMENT OF THE INVENTION

The present invention relates to a compact bottle processing device which, in particular, enables a plurality of bottles to be washed, filled and encapsulated automatically. The dimensions of the device, notably of the circuit traversed by the bottles between the moment they are placed on the conveyor unit and the moment they are removed from it, enable the device to be integrated into existing infrastructures such as restaurants or hotels, which cannot accommodate industrial-scale devices.

The proposed device enables a short circuit reuse of the bottles, in particular of the bottles intended for beverages such as mineral water, sparkling water, soft drinks, etc. Indeed, it is then possible to integrate a device within the beverage establishment that enables complete reuse of the bottles, thus avoiding the economic and environmental costs associated with transporting the bottles between a processing plant and the place of distribution/consumption.

Automating the cleaning, filling and encapsulation stages within the same device, and automatically conveying the bottles, also makes it possible to achieve a higher level of hygiene than non-industrial devices in which one or more of these stages are carried out by an operator handling the bottles.

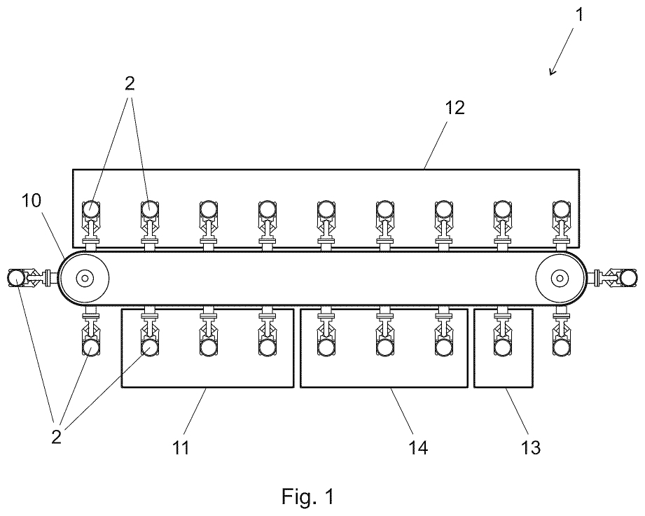

As schematically illustrated in FIG. 1, the device comprises a conveyor unit 10 for moving bottles along a closed circuit. A gripping area 11 enables an operator to place bottles, typically empty and dirty, on the conveyor unit 10, or to retrieve bottles, typically clean, filled and encapsulated, from the conveyor unit 10. Conveyor unit 10 is automated, so that bottles are moved along the closed circuit without operator intervention.

Along this closed circuit are arranged at least one cleaning station 12 for cleaning the conveyed bottles 2, a filling station 13 for filling the conveyed bottles 2 with a liquid, typically a beverage liquid, and an encapsulation station 14 for hermetically sealing the conveyed bottles 2 by means of a cap or capsule.

Advantageously, the length of the closed circuit determined by the conveyor unit 10 is less than or equal to 20 m, or even less than or equal to 15 m. Such a length enables the device 1 to be installed in the bottle distribution/consumption establishments. Indeed, for such a length, a floor area of less than 20 m², or even less than 15 m² is sufficient to accommodate the entire processing device. In one embodiment, the length of the closed circuit is even less than or equal to 10 m, and the device 1 requires no more than 9 m² to 10 m² to be installed.

In one embodiment, the cleaning station 12 operates by spraying the inside and outside of bottle 2 with a jet of detergent solution, typically a caustic-based detergent. The solution may be particularly alkaline. The cleaning station 12 may comprise a suction unit including a turbine for evacuating the detergent solution.

The cleaning station may comprise one or more successive jets for spraying the inside and outside of the bottle as it is moved by the conveyor unit 10.

The filling station 13 fills a bottle with a liquid, such as a beverage liquid. The filling station 13 therefore comprises one or more liquid inlet(s), e.g. still water, sparkling water. These liquid inlets are aligned with the positions of the bottles 2 on the conveyor unit 10 so as to enable automatic filling of the bottles when their position corresponds to that of a given liquid inlet.

In one embodiment, the filling station comprises several inlets for the same liquid, enabling the same bottle to be filled in several successive stages. This solution is advantageous for limiting turbulence during filling and maximizing carbonation in the case of sparkling water.

The encapsulation station 14 enables a bottle 2 to be resealed after filling by means of a cap, lid, stopper or any other hermetic closure. The term “encapsulation” station therefore does not limit the invention to closure by capsule, but on the contrary allows the use of any means of bottle closure deemed suitable by the person skilled in the art.

In one embodiment, encapsulation station 14 comprises a capsule dispensing unit 140 and a capsule crimping unit 141. These two units can be arranged consecutively along the closed circuit so that a bottle first passes through the capsule dispensing unit 140 so that a capsule is placed on the bottle neck, and then in a second time through the crimping unit 141 so that the deposited capsule is crimped on the neck. The positions of these two units thus correspond to successive positions of a bottle 2 conveyed by conveyor unit 10.

Alternatively, these two capsule dispensing 140 and crimping 141 units can be grouped together to form a single module that performs both dispensing and crimping. In this way, the position of the 140 dispensing and 141 crimping units corresponds to a single position of the bottle 2 being conveyed.

In one embodiment, the capsule dispensing unit 140 is a vibratory bowl provided with a ramp or rail for sliding a capsule from the vibratory bowl to the neck. In addition, the dispensing unit can include a capsule disinfection module for disinfecting capsules during dispensing. For example, the disinfection module enables a capsule to be disinfected by exposure to UV radiation during conveyance to the bottle, typically along a ramp or rail.

After passing through the cleaning, filling and encapsulation stations, a bottle 2 conveyed by conveyor unit 10 ends its journey at the gripping area 11, where an operator can pick it up manually or automatically.

As shown in FIG. 1, the conveyor unit 10 can advantageously comprise a plurality of gripper arms 100, each of which can support at least one bottle 2 throughout the closed circuit. At the gripping area 11, empty and dirty bottles 2 are arranged on a gripper arm 100. Advantageously, the gripper arm is configured to keep the bottle 2 clamped in order to avoid any movements that may result from the conveying operation and that could cause shocks.

In one embodiment, the gripper arms 100 comprise a clamp for gripping a bottle 2, for example around its neck or body. Alternatively or complementarily, each gripper arm can comprise a lower support on which a bottle is placed.

In one embodiment, each gripper arm 100 comprises a rotating wrist configured to allow rotation of a bottle 2 placed on the gripper arm 100. This rotation typically takes place in a vertical plane, so that the orientation of the bottle can be reversed during conveying, for example to facilitate cleaning in the cleaning station 12. However, if required, the bottle 2 can also be rotated in a non-vertical plane.

Rotating the bottle in this way allows, for example, the opening of the bottle neck to be matched with one or more jets from cleaning station 12. This makes it easier to wash the inside of the bottle. The orientation of the bottle, and therefore the angle of rotation of the rotating wrist, can thus depend on the orientation of the cleaning station jet(s).

Alternatively or additionally, the rotation of the rotating wrist can be used to align the neck opening of the conveyed bottle 2 with one or more liquid inlets in the filling station 13, so as to facilitate bottle filling. For example, it may be necessary to turn the bottle upside down after filling and/or adapt the angle of the neck to the liquid inlet, depending on the type of beverage. E.g. some gaseous liquids may require a particular angle between the neck and the liquid stream to minimize foaming during filling.

Alternatively or additionally, rotation of the rotating wrist aligns the neck opening of the conveyed bottle 2 with the encapsulation station 14. In particular with a capsule dispensing unit 140 and/or with a crimping unit 141. Indeed, the pressure forces exerted on the bottle 2 during encapsulation can be significant and require adequate alignment of the bottle's longitudinal axis with the tool exerting the pressure in order to avoid damaging the bottle.

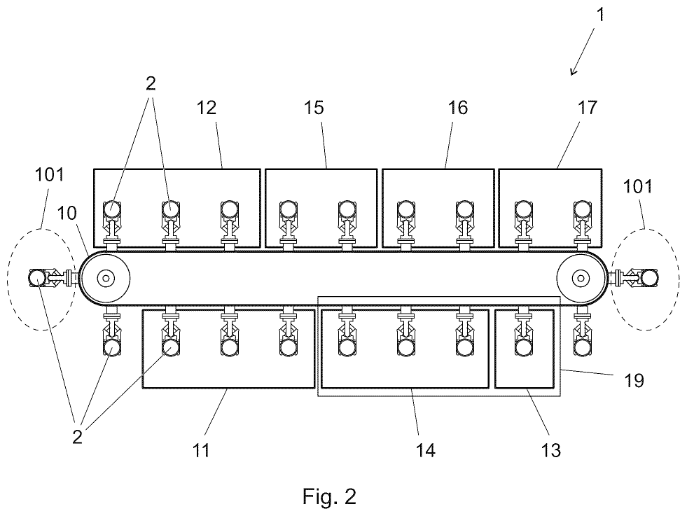

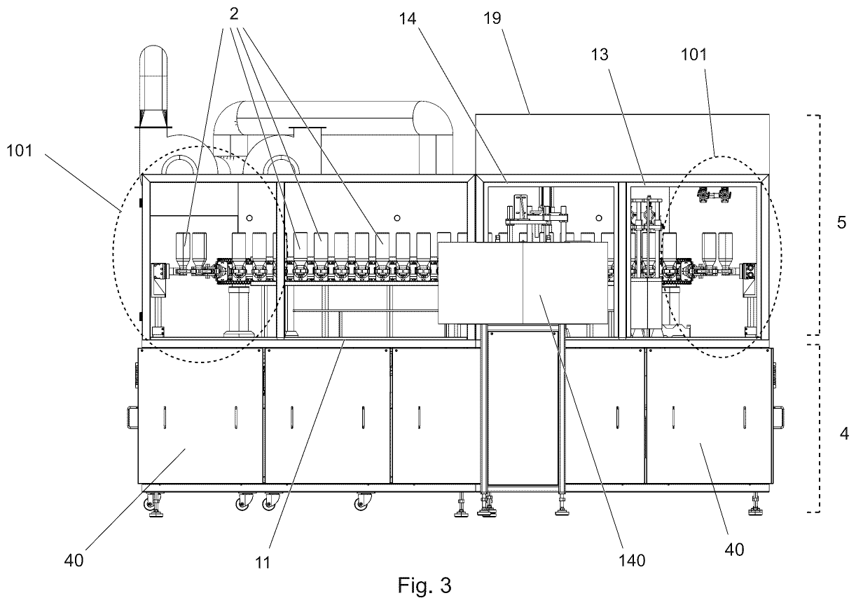

The closed circuit can therefore include rotation zones 101 of the bottles by rotating the rotating wrist of the gripper arm 100. These rotation zones 101 are advantageously located outside the cleaning, filling and encapsulation stations, to avoid any contact with elements of these stations. As illustrated in FIGS. 1 and 2, these rotation zones 101 can advantageously be located at the longitudinal ends of the closed circuit determined by the conveyor unit 10.

Thus, in one embodiment, an operator places an empty, dirty bottle 2 on a gripper arm 100 of the conveyor unit 10 in the gripping area 11, so that the neck opening faces upwards, then the bottle 2 is conveyed to the rotation zone 101 preceding the cleaning station 12, where it is turned by rotation of the rotating wrist of the gripper arm so as to align the neck opening with one or more jets from the cleaning station 12. After cleaning, the bottle is conveyed to a second rotation zone 101, where it is again rotated by the rotating wrist of the gripper arm so as to align the neck opening with one or more liquid inlets from the filling station 13.

These rotations are typically of the order of 180° each, so as to turn each bottle over completely in the rotation zones 101. However, other orientations can be achieved by means of the rotating wrist, notably in order to align the bottle with certain elements of the processing device, or according to the shape of the bottle.

In one embodiment, the rotating wrist allows rotation not only in a first plane (e.g. a vertical plane as described above), but also in a second plane (e.g. perpendicular to the first plane), and even allows 360° rotation of the bottle to achieve virtually any inclination.

In order to limit losses of cleaning liquid and/or filling liquid and/or to facilitate encapsulation, the conveyor unit can be configured to move the bottles fractionally rather than continuously. In this way, each bottle is moved along the closed circuit between two successive positions at time intervals. In this way, each bottle remains at each position for a predetermined time, so that the cleaning, filling and encapsulation steps can be carried out when the bottle is stationary at one position. The cleaning and/or filling jets can thus be interrupted while the bottles are in motion, to avoid losses.

In one embodiment, the conveyor unit 10 is configured to alternate a bottle movement phase between two successive positions and a stop phase with a time interval of between 5 seconds and 20 seconds, preferably with a time interval of around 10 seconds.

The gripping area 11 can be dimensioned so that a number of bottles between 5 and 10, typically 6 or 7, can be accessed simultaneously. In this way, an operator has enough time to pick up an empty, dirty bottle, place it on the conveyor unit 10, pick up a clean, full bottle on the conveyor unit and place it on an auxiliary device.

The gripping area 11 as described also advantageously eliminates the need for an accumulation table as in industrial devices. In this way, it is possible to increase the compactness of the device by eliminating a normally bulky element.

As shown in FIGS. 1 and 2, the closed circuit traversed by the bottles 2 on the conveyor unit 10 can be arranged in the form of an oblong loop. The arrangement of the various units and stations can vary along this oblong circuit, in the following order: gripping area 11, cleaning station 12, filling station 13, encapsulation station 14 and gripping area 11.

As shown in FIG. 2, the cleaning station and any other cleaning-related stations (soaking, drying, disinfecting, etc.) can be arranged along a first side of the oblong circuit, and the filling 13 and encapsulation 14 stations as well as the gripping area 11 can be arranged along a second side of the oblong circuit.

This advantageously enables the inlets/outlets for cleaning liquid, detergent, disinfectant and/or hot air, etc. to be separated from the inlets/outlets for beverage liquid and encapsulation elements (e.g. capsules/capsules, capsule dispensing ramp, etc.) in order to separate the circuit into a side dedicated to washing which may correspond to a first hygiene standard and a side dedicated to filling and encapsulation operations corresponding to a second hygiene standard higher or lower than the first hygiene standard.

This oblong loop may, for example, extend between two ends corresponding to the rotation zones 101 of the bottles when the conveyor unit 10 includes such zones.

The long sides of the closed circuit are advantageously between 2 m and 6 m long.

More generally, the external dimensions (length and width) of the processing device 1 do not exceed 5 m×5 m, preferably 4 m×4 m, or even 3 m×3 m in some embodiments. These external dimensions advantageously allow the device 1 to be installed in existing rooms of usual dimensions, thus requiring no special surface arrangements. This is often the case for establishments such as restaurants, hotels, etc. that do not have a floor space that can be extended as required. The device can thus be integrated into a room, e.g. a kitchen, a utility room, etc.

As shown in FIG. 2, the processing device 1 can optionally include one or more of the following stations: a rinsing station 15, a drying station 16, a disinfection station 17 and/or a printing station (not shown).

The device 1 may include one or more rinsing stations 15 for rinsing the inside and/or outside of bottles after passing through the cleaning station 12. The rinsing station may include a rinsing liquid inlet (typically filtered water to avoid residue traces).

The device 1 may include one or more drying station(s) 16 for drying a bottle 2 after it has passed through cleaning station 12 and/or rinsing station 15. The drying station may include a blower. Such a drying device is particularly useful for avoiding any drip marks (lime residues).

The device 1 may include one or more disinfection stations 17 for disinfecting a bottle 2 after it has passed through the cleaning 12, rinsing 15 and/or drying 16 station. The disinfection station may include an inlet/outlet for a disinfection solution for disinfecting the inside and/or outside of the bottle 2. This may be an acid solution, for example. The disinfection station may also include suction means, such as a suction turbine, to remove vapors from the solution.

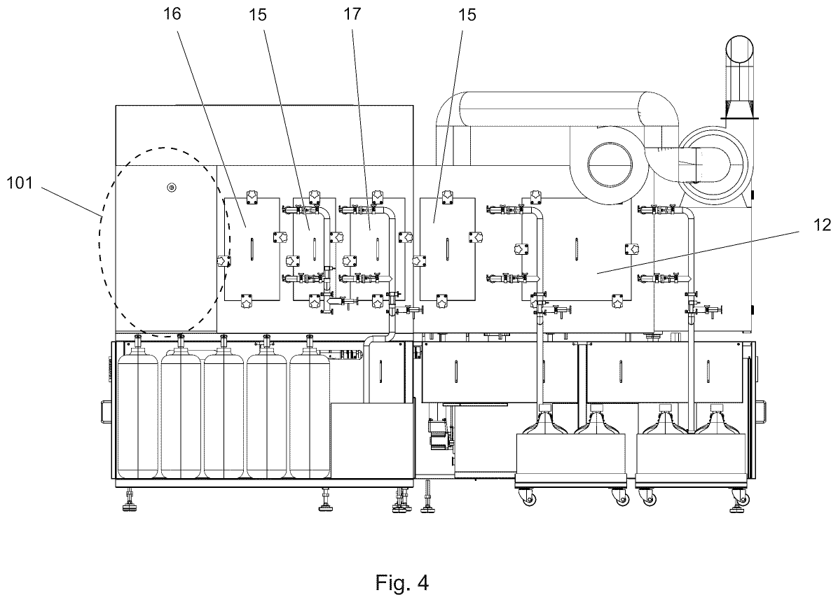

According to an embodiment illustrated in FIG. 4, the processing device 1 comprises a first rinsing station 15 arranged adjacent to the cleaning station 12, and a second rinsing station 15 arranged after the disinfection station 17. Finally, a drying station 16 is arranged downstream of the second rinsing station 15.

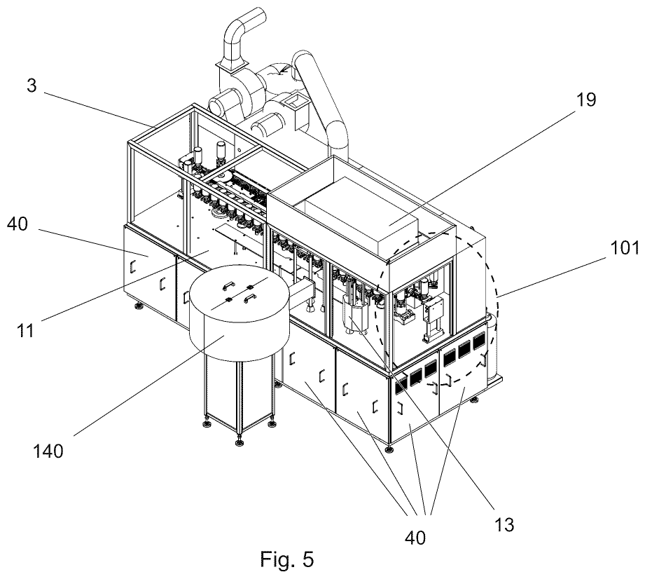

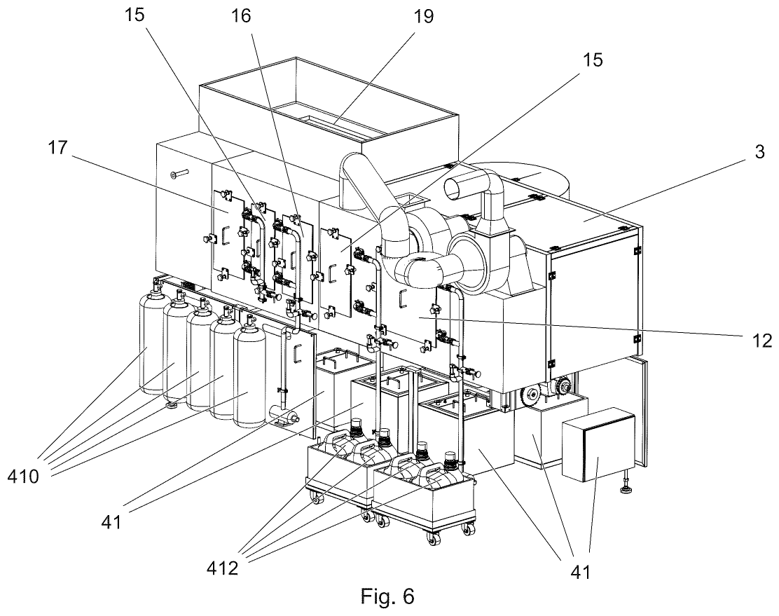

As illustrated in FIGS. 5 and 6, the processing device 1 can advantageously include a protective enclosure 3, arranged so as to prevent access to the conveyor unit 10 from outside the unit, with the exception of one or more dedicated areas. The presence of this protective enclosure results in an improved level of hygiene comparable to that of industrial bottle processing plants. Indeed, in the context of the present invention, cleaning, filling and encapsulation operations, as well as any other disinfection, rinsing, drying, printing operations, etc., do not require external intervention by an operator. It is thus possible to increase the hygiene level of the device 1 by prohibiting access to conveyor unit 10 outside areas explicitly dedicated to bottle handling by an operator. For example, the gripping area can be a zone, or even the only zone, for handling bottles 2. Contamination by direct handling is thus reduced to a minimum during the cleaning-filling-encapsulation cycle of each bottle.

According to an embodiment illustrated in FIGS. 5 and 6, the protective enclosure 3 may comprise a frame supporting a plurality of protective glass panes preventing access to the conveyor unit 10 from the side and/or from above/below, with the exception of access via the gripping area 11.

Alternatively, or in addition to the protective enclosure 3, the processing device 1 can also include an overpressure cabin 19, enabling at least one of the filling or encapsulation operations to be carried out in an overpressure environment in order to limit bacterial contamination. Such a cabin 19, illustrated in FIGS. 5 and 6, ensures that the pressure in the zone enclosed by cabin 19 is higher than the pressure outside, making it difficult, if not impossible, for bacteria to penetrate this zone. In this way, filling stations 13 and/or encapsulation stations 14 can be advantageously located inside the overpressure cabin 19.

The overpressure cabin 19 can be fitted with an air filtration device to further limit contamination. For example, the booster cabin may include an EPA (Efficiency Particulate Air) filter to filter out particles in the air.

According to another aspect of the invention, the bottle processing device 1 is arranged in a first stage 4 and a second stage 5 above the first stage. The first stage comprises a plurality of compartments 40 configured to contain operating units 41 of the cleaning 12, filling 13 and/or encapsulating 14 stations. The second stage comprises the conveyor unit 10 and the cleaning 12, filling 13 and encapsulating 14 stations.

In particular, this multi-stage arrangement reduces the footprint of the device, i.e. the floor space required for its operation. In fact, the second floor 4 contains the operating units for the device's stations (12, 13, 14), which are located on the second floor 5. In this way, a considerable amount of floor space can be saved.

Operating units 41 may contain one or more of the following elements: a pressurized vessel for gasifying a liquid 410, a compressor 411, a cleaning agent vessel 412 and/or a liquid filtration device 413, a pump (for liquid or for aeration), electrical and/or electronic power supply and/or control/command elements for the various stations (12,13,14).

According to an embodiment illustrated in FIG. 6, several pressurized vessels 410 in the form of CO2 bottles are arranged on the first stage 4. These vessels are dedicated to the gasification of a beverage liquid (typically water) whose bottles 2 are filled in the filling station 13. A number of cleaning agent vessels 412 can also be arranged on the first stage 4 in compartments 40 or outside.

The present invention also relates to a bottle processing method comprising the following steps:
placing an empty bottle 2 on a gripper arm 100 in a gripping area 11 of a bottle processing device 1 as described above,
cleaning the empty bottle 2 using the cleaning station 12,
filling the empty bottle 2 with a liquid using the filling station 13,
encapsulating the filled bottle 2 using the encapsulation station 14,
retrieving the filled and encapsulated bottle 2 from the gripper arm 100 in the gripping area 11.

The bottle placing and retrieving steps are carried out by an operator, and the bottle is automatically moved along the closed circuit by means of the conveyor unit 10. The cleaning 12, filling 13 and encapsulation 14 stations are arranged along the closed circuit as described above.

Optional steps for rotating the bottles placed on the gripper arms 100 can be performed, in particular to enable the bottle necks to be oriented in a cleaning direction, e.g. corresponding to a cleaning jet orientation in cleaning station 12, or to enable the bottle necks to be oriented in a filling direction, e.g. corresponding to a filling jet orientation in the filling station 13. These rotation steps are performed by each gripper arm using a rotating wrist as described above. These rotations are performed within the rotation zones 101.

In one embodiment, each bottle is rotated by 180° during the first rotation step and by 180° during the second rotation step.

### REFERENCE NUMERALS

1 Bottle processing device
10 Conveyor unit
100 Gripper arm
101 Rotation zone
11 Gripping area
12 Cleaning station
13 Filling station
14 Encapsulation station
140 Capsule dispensing unit
141 Capsule crimping unit
15 Rinsing station
16 Drying station
17 Disinfection station
18 Printing station
19 Overpressure cabin
2 Bottle
3 Protective enclosure
4 First stage
40 Compartment
41 Operating unit
410 Pressurized vessel
411 Compressor
412 Cleaning agent vessel
413 Filtration device
5 Second stage

1. Compact bottle processing device comprising:
an automatic bottle conveyor unit for moving a plurality of bottles along a closed circuit, a gripping area enabling an operator to place a bottle from the plurality of bottles on the conveyor unit and/or to pick up a bottle from the plurality of bottles on the conveyor unit,
a bottle cleaning station,
a bottle filling station,
a bottle encapsulation station,
each of these stations being arranged along the closed circuit, so that a bottle passes successively through the cleaning station, the filling station and the encapsulation station as it is moved by the conveyor unit,
wherein a length of the closed circuit is less than or equal to 20 m, preferably less than 15 m.

2. Device according to claim 1, the conveyor unit comprising a plurality of gripper arms, each gripper arm enabling supporting a bottle throughout the closed circuit.

3. Device according to claim 2, each gripper arm comprising a rotatable wrist for rotating a bottle arranged on the gripper arm.

4. Device according to claim 1, the conveyor unit being configured to move the plurality of bottles fractionally at time intervals between successive positions along the closed circuit.

5. Device according to claim 4, the time interval being between 5 and 20 seconds.

6. Device according to claim 1, the gripping area being dimensioned so as to be able to simultaneously accommodate a number of gripper arms of between 5 and 10.

7. Device according to claim 1, the closed circuit being oblong in shape.

8. Device according to claim 1, a width of the device being less than 5 m, preferably 4 m, and a length of the device being less than 5 m, preferably 4 m.

9. Device according to claim 1, comprising at least one additional station selected from: a rinsing station, a drying station, a disinfecting station and/or a printing station.

10. Device according to claim 1, comprising a protective enclosure arranged to prevent access to the conveyor unit from outside the device, with the exception of access via the gripping area.

11. Device according to claim 1, comprising an overpressure cabin, the filling station and the encapsulation station being arranged inside the overpressure cabin.

12. Device according to claim 1, the device being arranged in a first stage and a second stage above the first stage, the first stage comprising a plurality of compartments configured to contain operating units of the cleaning, filling and/or encapsulation stations, and the second stage comprising the conveyor unit and the cleaning, filling and encapsulation stations.

13. Device according to claim 12, the operating units comprising one or more of the following elements: a pressurized liquid gasification vessel, a compressor, a cleaning agent vessel and/or a liquid filtration device.

14. Device according to claim 1, the encapsulation station comprising a capsule dispensing unit and a capsule crimping unit.

15. Bottle processing method comprising the steps of:
placing the empty bottle on a gripper arm in a gripping area of a bottle processing device according to claim 1,
cleaning the empty bottle by means of a cleaning station of the processing device,
filling the empty bottle with a liquid by means of a filling station of the processing device,
encapsulating the filled bottle by means of an encapsulation station of the processing device,
retrieving the filled, encapsulated bottle from the gripper arm in the gripping area, the steps of arranging and retrieving the bottle being carried out by an operator and the bottle being moved automatically along a closed circuit by means of a conveyor unit of the processing device, the cleaning, filling and encapsulation stations being arranged along the closed circuit.

16. Method according to claim 15, comprising a first step of rotating the empty bottle prior to the cleaning step so as to orient a bottle neck in a cleaning direction, and a second step of rotating the empty bottle after cleaning and prior to filling so as to orient the bottle neck in a filling direction, both rotation steps being performed by means of a rotating wrist of the gripper arm on which the bottle is arranged.

17. Method according to claim 16, the bottle being rotated by 180° during the first rotation step and by 180° during the second rotation step.
